(19) United States
(12) Patent Application Publication
(10) Pub. No.: US 2026/0296201 A1
(43) Pub. Date: Oct. 1, 2026

(54) Reversible, Pyrotechnic Contacting Device for an Onboard High-Voltage Electrical System of a Motor Vehicle

(71) Applicant: Bayerische Motoren Werke Aktiengesellschaft, Muenchen (DE)

(72) Inventors: Julian BERNDT, Muenchen (DE); Florian PRITSCHER, Landshut (DE)

(21) Appl. No.: 19/489,807

(22) PCT Filed: Aug. 2, 2024
(86) PCT No.: PCT/EP2024/071991

§ 371 Date: Dec. 3, 2025

(30) Foreign Application Priority Data
Aug. 31, 2023 (DE) 10 2023 123 408.0

(51) Int. Cl. B60L 3/00; B60R 16/03; H01H 3/02; H01H 39/00

(52) U.S. Cl. CPC B60L 3/0007; B60R 16/03; H01H 3/022; H01H 39/004; H01H 2003/026

(57) ABSTRACT

A contacting device for an onboard high-voltage electrical system of a motor vehicle for providing a reversible electric connection between at least two onboard-electrical-system components of the onboard high-voltage electrical system, includes a switching unit for disconnecting the electric connection in a first switching state and for establishing the electric connection in a second switching state, an actuation unit for actuating the switching unit, and a pyrotechnic ignition unit for activating the actuation unit, with the actuation unit being designed, after having been activated by the pyrotechnic ignition unit, to perform a switching cycle of the switching unit.

### BACKGROUND AND SUMMARY

The invention relates to a contacting device for a high-voltage on-board electrical system of a motor vehicle for providing a reversible electrical connection between at least two on-board electrical system components of the high-voltage on-board electrical system. The contacting device comprises a switching unit for interrupting the electrical connection in a first circuit state, and for establishing the electrical connection in the second circuit state. The contacting device moreover comprises an actuation unit for actuating the switching unit, and a pyrotechnic ignition unit for activating the actuation unit. The invention further relates to a high-voltage on-board electrical system, and to a motor vehicle.

In the present context, the focus is directed towards high-voltage on-board electrical systems for motor vehicles, in particular for electric or hybrid vehicles. High-voltage on-board electrical systems of this type customarily comprise a high-voltage energy store, which store can be coupled, via an intermediate circuit, to other high-voltage components, for example to an electrical machine. In the event of a malfunction, for example in case of an accident which is sustained by the motor vehicle, it is customary, on the grounds of safety, for electrical connections between components of the high-voltage on-board electrical system to be interrupted and/or established, for example for the connection to the intermediate circuit of a discharge circuit for discharging the intermediate circuit. To this end, contacting devices are known from the prior art, which devices establish or interrupt the electrical connection by a pyrotechnic ignition unit or a propelling charge. In general, pyrotechnic contacting devices of this type are irreversible and thus, in consequence, can only either establish or interrupt the electrical connection.

A pyrotechnic contacting device in the form of a reversible safety device for the electrical connection and interruption of electrical conductors is known from DE 10 2019 211 725 A1. This safety device comprises an insulating housing and a void which is enclosed by the housing, in which void a safety element and a propelling charge are arranged, wherein the safety element comprises an electrically conductive connecting element and an electrically isolating disconnecting element. Ends of the electrical conductors are arranged in the housing in a mutually disconnected manner. For the safety element, a connected position and a disconnected position are provided wherein, in the connected position, the connecting element of the safety element is arranged between the ends of the electrical conductors. In the event that the propelling charge in the void is detonated, the safety element is displaced from the original connected position thereof to the disconnected position such that, in the disconnected position, the disconnecting element of the safety element is arranged between the ends of the electrical conductors. Moreover, the safety element, for example manually, can also execute a transition from the disconnected position back to the connected position. This manual resetting of the safety element is complex, and can only be executed by specialized personnel. Moreover, the contacting device described according to the prior art is inappropriate for the provision of rapid resetting, in the event that, for example, it is necessary for this resetting to be executed within milliseconds.

The object of the present invention is the provision of a secure, simple and rapidly resettable pyrotechnic electrical contacting device for a high-voltage on-board electrical system of a motor vehicle.

According to the invention, this object is fulfilled by a contacting device, by a high-voltage on-board electrical system, and by a motor vehicle having the features disclosed herein. Advantageous embodiments of the invention are also the subject matter of the description and the figures.

A contacting device according to the invention for a high-voltage on-board electrical system of a motor vehicle is employed for providing a reversible electrical connection between at least two on-board electrical system components of the high-voltage on-board electrical system. The contacting device comprises a switching unit for interrupting the electrical connection, in a first circuit state, and for establishing the electrical connection, in a second circuit state. The contacting device further comprises an actuation unit for actuating the switching unit, and a pyrotechnic ignition unit for activating the actuation unit. The actuation unit, further to the activation thereof by the pyrotechnic ignition unit, is designed to execute a switching cycle of the switching unit and, to this end, to implement a transition of the switching unit from one circuit state to the respective other circuit state for a predetermined time interval.

The invention moreover relates to a high-voltage on-board electrical system for a motor vehicle having at least two on-board electrical system components, and having at least one contacting device according to the invention. A motor vehicle according to the invention comprises a high-voltage on-board electrical system according to the invention. The motor vehicle is preferably configured as an electric or hybrid vehicle. In particular, the high-voltage on-board electrical system comprises on-board electrical system components in the form of high-voltage components of an electric drive train of the motor vehicle. For example, a first on-board electrical system component can be configured as a high-voltage intermediate circuit, and a second on-board electrical system component as a discharge circuit, wherein the contacting device is designed to electrically connect the intermediate circuit to the discharge circuit for a predetermined time interval in the event of a malfunction, for example in the event of a crash of the motor vehicle, for the discharging of intermediate circuit capacitances.

In particular, the contacting device is arranged in an electrical connecting line or high-voltage line of the high-voltage on-board electrical system. To this end, for example, the switching unit can comprise multiple electrical conductors, for example conductor rails, wherein terminal sections of the conductor rails can be configured as terminals of the contacting device, for example as plug-in contacts. This switching unit can assume two circuit states, namely, a first, open circuit state, in which the electrical connection is disconnected or interrupted, and a second, closed circuit state, in which the electrical connection is established. For the provision of switching processes, i.e. for the transition of the switching unit from the first circuit state to the second, and from the second circuit state to the first, the actuation unit is provided, which unit is activated by the pyrotechnic ignition unit. The pyrotechnic ignition unit comprises at least one ignition element, for example a firing pellet or detonator, which ignition element can be ignited by at least one ignition process. The actuation unit which is activated by the ignited ignition unit is designed to execute a full switching cycle. In other words, the actuation unit executes two switching processes, wherein the switching unit is shifted from one circuit state to the other circuit state and, further to the expiry of the predetermined time interval, executes a transition back to the original circuit state, and is thus reset. In particular, the predetermined time interval does not exceed a maximum of a few milliseconds.

Further to the activation thereof by the pyrotechnic ignition unit, the actuation unit is preferably designed to execute the transition of the switching unit from the first, open circuit state to the second, closed circuit state and, further to the expiry of the predetermined time interval, to execute the transition thereof back to the first circuit state. Thus, for the predetermined time interval, the contacting device establishes the electrical connection, for example for connecting the discharge circuit to the intermediate circuit and, thereafter, interrupts the connection once more and isolates the high-voltage on-board electrical system.

The contacting device according to the invention thus comprises a switching unit which is switchable and resettable exclusively by the ignition unit. Thus, in an advantageous manner, no manual resetting of the switching unit is required, and the switching unit is also appropriate for the execution of rapid switching processes.

According to one configuration of the invention, the actuation unit comprises an actuating element which is moveable by the pyrotechnic ignition unit, which actuating element is designed to move a moveable contact part for the establishment of at least one of the circuit states. In particular, the contacting device comprises a housing in which a subsection of the switching unit, the actuation unit and the ignition unit are arranged, wherein the housing partially comprises a guide cylinder for the actuating element, which is configured in the form of a piston. For example, the terminals of the switching unit for connecting the contacting device to the electrical connecting line of the high-volage on-board electrical system can project from the housing. The, in particular piston-shaped actuating element is designed to transmit the movement thereof, which movement is initiated by the ignition unit, to the moveable contact part. The piston can execute a linear motion in the guide cylinder, and thus move the moveable contact part for the execution of at least one of the switching processes.

It can be provided that the switching unit comprises two electrical conductors, for example conductor rails, wherein the moveable contact part is configured as a subregion of one of the conductors which is bendable by the actuating element. In the first circuit state, the bendable subregion of one conductor, for example of one conductor rail, is arranged with a clearance to the other conductor, which conductor comprises a stationary contact point. The stationary contact point can be, for example, a terminal section of the other conductor rail which is arranged in the housing. For the closing of the switching unit, and thus for the transition of the switching unit from the first circuit state to the second, the actuating element bends the bendable subregion, conversely to the spring force, in the direction of the stationary contact point of the other conductor rail, and thus electrically connects the two conductor rails.

It can also be provided that the moveable contact part and the actuating element are configured as a single component. The moveable contact part, for example, can be fastened to the actuating element, and thus moved or driven in combination with the actuating element. The movement of the actuating element thus corresponds to the movement of the moveable contact part. The moveable contact part thus forms an electrically conductive connector, which connector, for example in the first circuit state, is arranged with a clearance to two stationary contact points of the two conductors of the switching unit and which, in the second circuit state, is arranged in contact with the two stationary contact points. For example, the actuating element can be configured as a piston, and the moveable contact part can be configured as a slipring which encloses the piston.

According to a first variant of the invention, for the execution of the switching cycle, the ignition unit comprises two ignition units which are ignitable with a temporal offset, which ignition units are designed to move the actuating element, and thus the moveable contact part, in mutually opposing directions with a temporal offset, in order to execute the switching cycle. The ignition elements are exemplarily arranged on opposing sides of the actuating element, in the guide cylinder. For closing the switching unit, firstly, a first ignition unit is triggered by a first ignition signal, which ignition signal moves the actuating element in a first direction, and thus contact-connects the moveable contact part with the stationary contact part of the switching unit. For the re-opening of the switching unit, further to a predefined time interval, the second ignition unit is triggered by a second ignition signal, which ignition signal moves the actuating element in a second direction, which direction is in opposition to the first direction, and thus releases the movable contact part, at least in part, from the stationary contact part.

According to a second variant of the invention, for the execution of the switching cycle, the ignition unit comprises two ignition elements which are ignitable with a temporal offset, and the actuation unit comprises a disconnecting element, wherein a first ignition element is designed to move the actuating element, and thus the moveable contact part, for the establishment of the second circuit state, and a second ignition element is designed to move the disconnecting element for the establishment of the first circuit state, which disconnecting element interrupts at least one conductor of the switching unit, in particular down-circuit of the moveable contact part. The actuation unit thus comprises the actuating element for closing the switching unit, and the electrically isolating disconnecting element for opening the switching unit. In this context, it is thus provided that the disconnecting element opens the switching unit, not only by the movement of the moveable contact part, but also by the interruption of at least one of the conductors of the switching unit. The disconnecting element can also be configured in the form of a piston which is moveable in a guide cylinder. Exemplarily, in each case, an ignition element can be arranged in mutually opposing guide cylinders, such that the actuating element is moved along the first direction, and the disconnecting element is moved along the second direction.

According to a third variant of the invention, for the execution of the switching cycle, the pyrotechnic ignition unit comprises an ignition element, which ignition element is designed to move the actuating element, and thus the moveable contact part along one direction. As a result, the moveable contact part, for the predetermined time interval, engages in a sliding contact with a stationary contact part of the switching unit, in order to establish the closed circuit state. According to this variant, the moveable contact part is displaced past the stationary contact part, such that contact is established in a temporary manner only, by way of a wiping contact or sliding contact. The predetermined time interval during which the electrical connection is established can thus be exemplarily adjusted by the sliding speed of the actuating element and/or by the geometrical dimensions of the moveable contact part.

Variants of the invention according to which two ignition elements, and thus two ignition processes, are required for executing a switching cycle provide an advantage in that the second ignition process is freely selectable by the application of the second ignition signal, and the predetermined time interval is thus adjustable in a flexible manner. Variants of the invention according to which only one ignition element, and thus only one ignition process, is required for executing a switching cycle provided an advantage in that the contacting device can be configured in a particularly simple and cost-effective manner.

It has proved to be advantageous if the contacting device comprises at least one discharge element, for example a discharge resistor, which discharge element is arranged in a housing in combination with the actuation unit, the ignition unit and the switching unit. The contacting device is thus configured as a highly-integrated component. The discharge element is electrically connected to the switching unit. By the short-term closing of the switching unit, by the pyrotechnically actuatable actuation unit, the intermediate circuit is connected to the integrated discharge resistor of the contacting device, for the purposes of discharging, and is thereafter isolated therefrom, further to discharging.

Embodiments, and the advantages thereof, disclosed with respect to the contacting device according to the invention apply correspondingly to the high-voltage on-board electrical system according to the invention, and to the motor vehicle according to the invention.

Further features of the invention proceed from the claims, the figures, and the description of the figures. Features and combinations of features specified in the preceding description, and features and combinations of features specified hereinafter in the description of the figures and/or represented in the figures alone, are not only applicable in the respectively indicated combination, but also in other combinations, or in isolation.

The invention is described in greater detail hereinafter with respect to a preferred exemplary embodiment, and with reference to the drawings.

### BRIEF DESCRIPTION OF THE DRAWINGS

FIGS. 1a, 1b and 1c show a schematic representation of a first configuration of a contacting device, in different circuit states;

FIGS. 2a, 2b and 2c show a schematic representation of a second configuration of a contacting device, in different circuit states;

FIGS. 3a, 3b and 3c show a schematic representation of a third configuration of a contacting device, in different circuit states; and

FIGS. 4a, 4b and 4c show a schematic representation of a fourth configuration of a contacting device, in different circuit states.

### DETAILED DESCRIPTION OF THE DRAWINGS

In the figures, identical and functionally equivalent elements are identified by the same reference symbols.

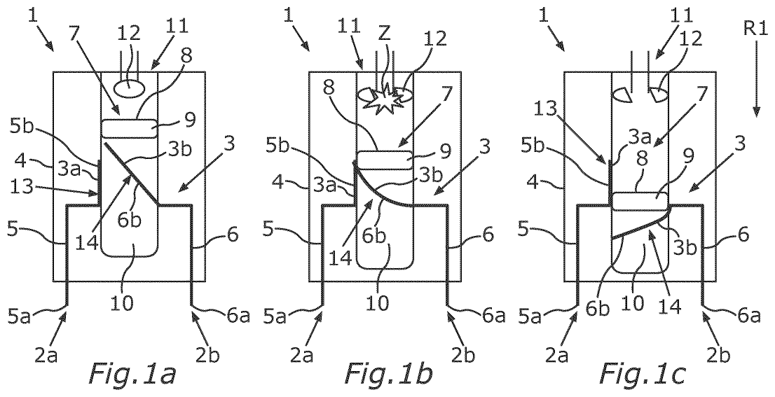

In each case, FIGS. 1a, 1b and 1c, FIGS. 2a, 2b and 2c, FIGS. 3a, 3b and 3c, and FIGS. 4a, 4b and 4c show one switching cycle in different configurations of a contacting device 1 for a high-voltage on-board electrical system of a motor vehicle. By the contacting device 1, within a switching cycle, on-board electrical system components of the high-voltage on-board electrical system are electrically connected, in a temporary manner, for a specific time interval.

On-board electrical system components of this type, for example, can comprise an intermediate circuit and a discharge circuit, which circuits, in the event of a vehicle crash, can be temporarily interconnected prior to the safety isolation of the high-voltage on-board electrical system. To this end, the contacting device 1 comprises terminals 2a, 2b, for example plug-in contacts, by which the contacting device 1 can be incorporated in a high-voltage conductor of the high-voltage on-board electrical system, which high-voltage conductor connects the on-board electrical system components.

The contacting device 1 comprises a switching unit 3 having a stationary contact part 3a and a moveable contact part 3b. The switching unit 3 is partially arranged in a housing 4 of the contacting device 1. The switching unit 3 comprises electrical conductors 5, 6, in the present case conductor rails, the first end sections 5a, 6a of which project out of the housing 4 and form the terminals 2a, 2b of the contacting device 1. For actuating, and thus for switching the switching unit 3, the contacting device 1 comprises an actuation unit 7 which, in the present case, comprises an actuating element 8. The actuating element 8 is exemplarily configured in the form of a piston 9 which is mounted in a linearly displaceable manner in a guide cylinder 10 of the housing 4. The contacting device 1 moreover comprises a pyrotechnic ignition unit 11 which comprises at least one ignition element 12 and is designed to activate the actuation unit 7 by an ignition process of the ignition element 12. By the activation of the actuation unit 7, the actuating element 8 is moved, which movement is transmitted to the moveable contact part 3b, and thus switches the switching unit 3.

According to FIGS. 1a, 2a, 3a and 4a, the switching unit 3 assumes a first, open circuit state, in which on-board electrical system components are electrically isolated. In the event of a malfunction, for example in the event of an accident, the switching unit 3, for the predetermined time interval, is switched from the first, open state to a second closed state, which state is represented in FIGS. 1b, 2b, 3b and 4b. As a result, for example, the intermediate circuit is temporarily electrically connected to the discharge circuit, and is discharged. Thereafter, further to the expiry of the predetermined time interval, the switching unit 3 is switched back from the second, closed circuit state to the first, open circuit state, which state is represented in FIGS. 1c, 2c, 3c and 4c. As a result, the on-board electrical system components are again mutually electrically isolated, and the high-voltage on-board electrical system is released for the provision of a secure state of the motor vehicle.

In a first configuration of the contacting device 1 according to FIGS. 1a, 1b and 1c, the stationary contact part 3a is formed by a stationary contact point 13 of a second end section 5b of the conductor rail 5, and the moveable contact part 3b is formed by a bendable subregion 14 of a second end section 6b of the conductor rail 6. The ignition unit 11 comprises one ignition element 12. In the open circuit state of the switching unit 3 according to FIG. 1a, the ignition element 12 is untriggered, the actuating element 8 is situated in a first position, and the moveable contact part 3b assumes a first setting, in which the moveable contact part 3b is arranged with an at least partial clearance to the stationary contact part 3a. In this case, the bendable subregion 14 is bent upwards, and thus does not engage in contact with the stationary contact point 13.

For the temporary closing of the switching unit 3, for example by signal control, an ignition process Z of the ignition element 12 is initiated, as represented in FIG. 1b, as a result of which the actuating element 8 moves along a first direction R1 into a second position, and the moveable contact part 3b thus assumes a second setting, in which setting the moveable contact part 3b contact-connects the stationary contact part 3a. In this case, the bendable subregion 14 is bent by the actuating element 8 in the direction of the stationary contact point 13, until such time as the bendable subregion 14 and the contact point 13 engage in contact, and the conductor rails 5, 6 are thus electrically connected. Further to the expiry of the time interval, the switching unit 3, as represented in FIG. 1c, is re-opened. To this end, in response to the ignition process Z, the actuating element 8 which has been moved according to FIG. 1b is further moved along the first direction R1 into a third position, and the moveable contact part 3b thus assumes a third setting, in which the moveable contact part 3b is again arranged with a clearance from the stationary contact part 3a. In this case, the bendable subregion 14 is bent downwards by the actuating element 8, and the electrical connection between the conductor rails 5, 6 is thus re-interrupted. Thus, for the execution of the switching cycle, as represented in FIGS. 1a to 1 c, only one ignition process Z is required, by which the bendable subregion 14 is displaced past the stationary contact point 13, and engages in temporary contact therewith.

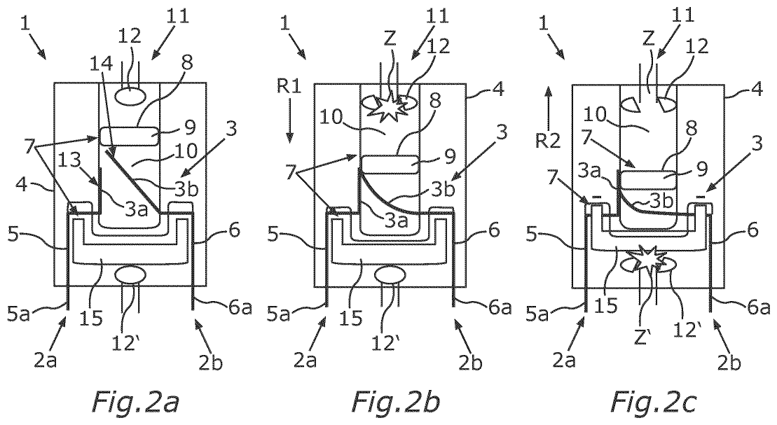

FIGS. 2a to 2c show the switching cycle according to a second configuration of the contacting device 1. This configuration is distinguished from the first configuration in that the ignition unit 11, additionally to the ignition element 12, comprises a further ignition element 12′, and in that the actuation unit 7, additionally to the actuating element 8, comprises a disconnecting element 15. According to FIG. 2a, the switching unit 3 assumes the first, open circuit state. Both the ignition elements 12, 12′ are untriggered, the actuating element 8 and the disconnecting element 15 are respectively situated in a first position, and the moveable contact part 3b assumes a first setting, in which the moveable contact part 3b is at least partially arranged with a clearance from the stationary contact part 3a. For the provision of the second circuit state (see FIG. 2b), as described above in conjunction with FIG. 1b, the first ignition element 12 is triggered, as a result of which the actuating element 8 is moved along the first direction R1 into the second position, and the moveable contact part 3b thus assumes a second setting, in which the moveable contact part 3b contact-connects the stationary contact part 3a. The second ignition element 12′ remains untriggered, and the disconnecting element 15 remains in the first position. Further to the expiry of the time interval, as represented in FIG. 2c, a further ignition process Z′ of the second ignition element 12′ is executed for opening the switching unit 3, such that the disconnecting element 15 is moved from the first position R1, along a second direction R2, which direction is in opposition to the first direction R1, into a second position, in which the disconnecting element 15 interrupts the electrical connection which is established by the conductor rails 5, 6. In this case, the disconnecting element 15 interrupts the conductor rails 5, 6. Thus, for the execution of the switching cycle, as represented in FIGS. 2a to 2c, two ignition processes Z, Z′ are required.

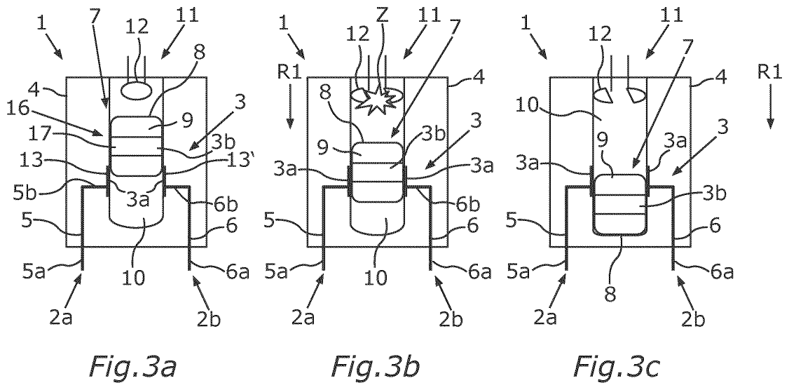

FIGS. 3a to 3c show the switching cycle according to a third configuration of the contacting device 1. This configuration is distinguished from the first configuration, in that the moveable contact part 3b and the actuating element 8 are configured as a single component 16. In this case, the moveable contact part 3b is configured in the form of a slipring 17 which encloses the piston 9. In this case, the stationary contact part 3a is formed by two stationary contact points 13, 13′ of the second end sections 5b, 6b of the conductor rails 5, 6. Upon the movement of the component 16, both the actuating element 8 and the moveable contact part 3b are moved. During the switching cycle, by an ignition process Z of the ignition element 12, the slipring 17 is displaced along a first direction R1 past the contact points 13, 13′, and thus contact-connects the latter in a temporary manner, as represented in FIG. 3b.

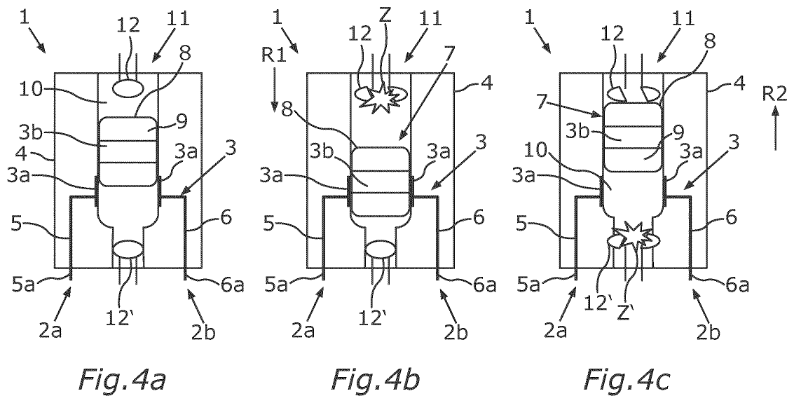

FIGS. 4a to 4c show the switching cycle according to a fourth configuration of the contacting device 1. This configuration is distinguished from the third configuration in that the ignition unit 11 in turn comprises two ignition elements 12, 12′, which elements, for the switching and resetting of the switching unit 3, are triggered with a temporal offset. During the first ignition process Z of the ignition element 12, according to FIG. 4b, the actuating element 8, and thus the stationary contact element 3b, are moved from the first position along the first direction R1 into a second position, in which the slipring 17 engages in contact with the stationary contact points 13, 13′. During the second ignition process Z′ of the second ignition element 12′, according to FIG. 4c, the actuating element 8, and thus the stationary contact element 3b, are moved back from the second position along the second direction R2 into the first position, and the switching unit 3 is thus re-opened.

1-14. (canceled)

15. A contacting device for a high-voltage on-board electrical system of a motor vehicle for providing a reversible electrical connection between at least two on-board electrical system components of the high-voltage on-board electrical system, the contacting device comprising:
a switching unit configured to interrupt the electrical connection in a first circuit state, and establish the electrical connection in a second circuit state;
an actuation unit configured to actuate the switching unit; and
a pyrotechnic ignition unit configured to activate the actuation unit,
wherein the actuation unit is configured to, further to the activation of the pyrotechnic ignition unit, execute a switching cycle of the switching unit.

16. The contacting device according to claim 15,
wherein the actuation unit is configured to:
further to the activation thereof by the pyrotechnic ignition unit, execute a transition of the switching unit from the first circuit state to the second circuit state; and
further to expiry of a predetermined time interval, execute a transition thereof back to the first circuit state.

17. The contacting device according to claim 15,
wherein the actuation unit comprises an actuating element that is moveable by the pyrotechnic ignition unit, which actuating element is configured to move a moveable contact part of the switching unit to establish at least one of the circuit states.

18. The contacting device according to claim 17,
wherein the contacting device comprises a housing in which a subsection of the switching unit, the actuation unit, and the ignition unit are arranged, wherein the housing comprises a guide cylinder for the actuating element that is configured in a form of a piston.

19. The contacting device according to claim 17,
wherein the ignition unit comprises two ignition elements configured to move the actuating element, and thus move the moveable contact part, in two mutually opposing directions for execution of the switching cycle with a temporal offset.

20. The contacting device according to claim 17,
wherein the ignition unit comprises, for execution of the switching cycle, two ignition elements which are ignitable with a temporal offset,
wherein the actuation unit comprises a disconnecting element,
wherein a first ignition element is configured to move the actuating element, and thus the moveable contact part, for executing a transition of the switching unit from the first circuit state to the second circuit state, and
wherein a second ignition element is configured to move the disconnecting element for resetting the switching unit in the first circuit state, which second ignition element mechanically interrupts at least one conductor section of the switching unit down-circuit of the moveable contact part.

21. The contacting device according to claim 17,
wherein the pyrotechnic ignition unit comprises, for execution of the switching cycle, an ignition element that is configured to move the actuating element, and thus move the moveable contact part, along one direction, wherein the moveable contact part temporarily engages in a sliding contact with a stationary contact part of the switching unit for establishment of a closed circuit state.

22. The contacting device according to claim 17,
wherein the switching unit comprises two electrical conductors, wherein the moveable contact part is configured as a subregion of one of the two electrical conductors that is bendable by the actuating element.

23. The contacting device according to claim 17,
wherein the moveable contact part and the actuating element are configured as a single component.

24. The contacting device according to claim 23,
wherein the actuating element is configured as a piston, and the moveable contact part is configured as a slipring that encloses the piston.

25. The contacting device according to claim 15,
wherein the contacting device comprises at least one discharge element that is electrically connected to the switching unit, wherein the at least one discharge element, the actuation unit, the ignition unit, and the switching unit are arranged in a common housing.

26. A high-voltage on-board electrical system for a motor vehicle comprising:
at least two on-board electrical system components; and
the contacting device according to claim 15.

27. The high-voltage on-board electrical system according to claim 26,
wherein a first on-board electrical system component is configured as a high-voltage intermediate circuit, and a second on-board electrical system component is configured as a discharge circuit,
wherein the contacting device is configured to temporarily electrically connect the high-voltage intermediate circuit to the discharge circuit, in an event of a malfunction, for discharging thereof.

28. A motor vehicle comprising:
the high-voltage on-board electrical system according to claim 26.
